(19) United States
(12) Patent Application Publication
(10) Pub. No.: US 2012/0177181 A1
(43) Pub. Date: Jul. 12, 2012

(54) RADIOGRAPHIC IMAGING DEVICE AND RADIOGRAPHIC IMAGING SYSTEM

(75) Inventor: Takao KUWABARA, Ashigarakami-gun (JP)

(73) Assignee: FUJIFILM CORPORATION, Tokyo (JP)

(21) Appl. No.: 13/339,124

(22) Filed: Dec. 28, 2011

(30) Foreign Application Priority Data
Jan. 12, 2011 (JP) 2011-004273

(51) Int. Cl. G01N 23/20

(52) U.S. Cl. 378/86

(57) ABSTRACT

There is provided a radiographic imaging device including: a radiation source that irradiates radiation generated by inverse Compton scattering; a first grating at which first members that diffract or absorb radiation are formed side by side such that pitches thereof are larger where distances from a center position of the radiation irradiated from the radiation source are larger, the first grating diffracting or absorbing radiation irradiated from the radiation source with the first members; a second grating that is disposed at a position at which Talbot interference is produced by the radiation diffracted or absorbed by the first grating, and at which second members that absorb radiation are formed side by side such that pitches thereof are larger where distances from the center position of the radiation irradiated from the radiation source are larger; and a radiation detector that detects radiation that has passed through the second grating.

### CROSS-REFERENCE TO RELATED APPLICATION

This application is based on and claims priority under 35 USC 119 from Japanese Patent Application No. 2011-004273 filed on Jan. 12, 2011, the disclosure of which is incorporated by reference herein.

### BACKGROUND

1. Technical Field

The present invention relates to a radiographic imaging device and a radiographic imaging system, and particularly relates to a radiographic imaging device and radiographic imaging system that capture a radiographic image using Talbot interference.

2. Related Art

A characteristic of X-rays is that they attenuate depending on the atomic numbers of the elements constituting materials, and on densities and thicknesses of the materials. Accordingly, X-rays are used as probes for observing the interiors of imaging subjects. Imaging using X-rays is widely employed in fields such as medical diagnostics, non-destructive testing and so forth.

In an ordinary X-ray imaging system, an imaging subject is disposed between an X-ray source that radiates X-rays and an X-ray image detector that detects the X-rays. The X-rays radiated from the X-ray source toward the X-ray image detector are subject to attenuation (absorption) in accordance with differences in characteristics (atomic numbers, densities and thicknesses) of materials that are present on paths to the X-ray detector, and are incident on pixels of the X-ray image detector. Hence, an X-ray absorption image of the imaging subject is detected by the X-ray image detector and converted to an image. Besides combinations of X-ray sensitized paper and film, photostimulable phosphors and the like, flat panel detectors (FPD) that employ semiconductor circuits are widely used as X-ray image detectors.

However, because X-ray absorption is lower in materials that are formed of elements with small atomic numbers, sufficient light and shade (contrast) is not obtained in an image that is an X-ray absorption image of biological soft tissues or of soft materials or the like. For example, the cartilage portions that structure joints in the human body and the synovial fluid that surrounds the cartilage portions are both almost entirely constituted of water, so differences between X-ray absorption amounts of the two are small. Therefore, it is hard to obtain contrast therebetween.

Accordingly, in recent years, research has been conducted into X-ray phase imaging that obtains an image (hereinafter referred to as a phase contrast image) based on X-ray phase changes (angle changes) caused by an imaging subject rather than X-ray intensity changes caused by the imaging subject. It is known that, generally, when an X-ray is incident on a body, the X-ray phase interacts with the body more strongly than the X-ray intensity does. Therefore, even with weakly absorbing bodies that have low X-ray absorption, high contrast images may be obtained with X-ray phase imaging that utilizes phase differences. As one kind of this X-ray phase imaging, X-ray imaging systems have been proposed in recent years (for example, see Japanese Patent Application Laid-Open (JP-A) Nos. 2008-14511 and 2008-200361) that use X-ray Talbot interferometers constituted by two transmissive diffraction gratings (a phase grating and an absorption grating) and an X-ray image detector.

In a related art X-ray tube that is used as a radiation source, when an applied tube voltage is altered and X-rays are generated, a peak energy changes and X-rays with different energies are generated. The energy of an X-ray and the wavelength λ, of an X-ray have the relationship E=hc/λ, (h is the Planck constant and c is the speed of light), and the wavelengths λ are different for different energies E. That is, X-rays with a number of different wavelengths are included in the X-rays generated by the related art X-ray tube.

Accordingly, as a technology for generating X-rays with a uniform wavelength characteristic, a technology has been proposed (JP-A No. 2002-162371) in which laser light is caused to collide with an accelerated electron beam and X-rays are generated by inverse Compton scattering.

Because an X-ray Talbot interferometer provides a phase contrast image based on X-ray phase changes caused by an imaging subject, it is preferable to perform imaging by irradiating X-rays with a uniform wavelength characteristic.

Accordingly, using a radiation source that generates X-rays by inverse Compton scattering is being considered.

However, X-rays that are generated by inverse Compton scattering at a point of collision between a laser light and an electron beam vary depending on angle, in that X-rays that are at larger angles with respect to the direction of travel of the electron beam have lower energies and longer wavelengths.

Therefore, if a radiation source that generates X-rays by inverse Compton scattering is simply used in an X-ray Talbot interferometer, because the distance at which a self-image is formed by Talbot interference varies with the wavelength of X-rays, an excellent phase contrast image may not be provided.

### SUMMARY

The present invention has been made in view of the problem described above, and an object of the present invention is to provide a radiographic imaging device and radiographic imaging system capable of providing an excellent phase contrast image when a radiation source that irradiates radiation by inverse Compton scattering is used.

In order to achieve the object described above, the first aspect of the present invention provides a radiographic imaging device including:

a radiation source that irradiates radiation generated by inverse Compton scattering;

a first grating at which first members that diffract or absorb radiation are formed side by side such that pitches thereof are larger where distances from a center position of the radiation irradiated from the radiation source are larger, the first grating diffracting or absorbing radiation irradiated from the radiation source with the first members;

a second grating that is disposed at a position at which Talbot interference is produced by the radiation diffracted or absorbed by the first grating, and at which second members that absorb radiation are formed side by side such that pitches thereof are larger where distances from the center position of the radiation irradiated from the radiation source are larger; and

a radiation detector that detects radiation that has passed through the second grating.

In the present invention, the radiation generated by inverse Compton scattering is irradiated from the radiation source. The radiation irradiated from the radiation source is diffracted by the plural first members that are formed side by side at the first grating and deflect or absorb the radiation, and produces the Talbot effect. The radiation diffracted or absorbed by the first grating is transmitted and absorbed by the second grating that is disposed at a position at which Talbot interference is generated by the radiation diffracted or absorbed by the first grating. The radiation transmitted by the second grating is detected by the radiation detector.

In the present invention, the first members of the first grating and the second members of the second grating are formed with larger pitches between the members where the distances from the central position of the radiation irradiated from the radiation source are larger.

Thus, according to the first aspect of the present invention, because the first members of the first grating and the second members of the second grating are formed such that the greater the distance from the central position of the radiation irradiated from the radiation source, the larger the spacing between the members, even though radiation irradiated from a radiation source such as a radiation source that irradiates radiation by inverse Compton scattering varies depending on angle, positions at which Talbot interference is generated by the radiation diffracted by the first members may be kept to within a certain range. Therefore, even though the radiation source that irradiates radiation by inverse Compton scattering is used, an excellent phase contrast image may be obtained.

The second aspect of the present invention provides the radiographic imaging device according to the first aspect, wherein the first members are formed such that the pitches between the first members are larger in proportion to the square roots of wavelengths λ of the radiation irradiated at respective positions of the first grating from the radiation source.

The third aspect of the present invention provides the radiographic imaging device according to the first aspect, wherein the second members are formed with pitches that are larger than the pitches of the first members of the first grating by a ratio of a distance from the radiation source to the second grating to a distance from the radiation source to the first grating.

The fourth aspect of the present invention provides the radiographic imaging device according to the first aspect, wherein

the radiation source is capable of separately irradiating radiations with different energies, and

pluralities of the first grating and the second grating are prepared with different degrees of change of the pitches between the first members and between the second members, and the first grating and second grating are exchangeable.

The fifth aspect of the present invention provides the radiographic imaging device according to the fourth aspect, wherein the radiation source separately irradiates the radiations with different energies in accordance with at least one of types and thicknesses of portions to be imaged.

The sixth aspect of the present invention provides the radiographic imaging device according to the first aspect, wherein the first members of the first grating and the second members of the second grating are formed such that thicknesses thereof are thinner where the distances from the center position of the radiation irradiated from the radiation source are larger.

The seventh aspect of the present invention provides a radiographic imaging system including:

a radiation source that irradiates radiation generated by inverse Compton scattering;

a first grating at which first members that diffract or absorb radiation are formed side by side such that pitches thereof are larger where distances from a center position of the radiation irradiated from the radiation source are larger, the first grating diffracting or absorbing radiation irradiated from the radiation source with the first members;

a second grating that is disposed at a position at which Talbot interference is produced by the radiation diffracted or absorbed by the first grating, and at which second members that absorb radiation are formed side by side such that pitches thereof are larger where distances from the center position of the radiation irradiated from the radiation source are larger; and

a radiation detector that detects radiation that has passed through the second grating.

Thus, according to the present invention, by operations as the same as in the first aspect, even when a radiation source that irradiates radiation by inverse Compton scattering is used, an excellent phase contrast image may be provided.

According to the present invention, an advantageous effect is provided in that, even when a radiation source that irradiates radiation by inverse Compton scattering is used, an excellent phase contrast image may be obtained.

### BRIEF DESCRIPTION OF THE DRAWINGS

Exemplary embodiments of the present invention will be described in detail based on the following figures, wherein:

FIG. 1 is a schematic diagram illustrating schematic structure of an X-ray imaging device relating to an exemplary embodiment;

FIG. 2 is a structural diagram illustrating structure of a radiation source relating to the exemplary embodiment;

FIG. 3 is a diagram illustrating variations in energy of X-rays irradiated from the radiation source as proportional decreases in energy from the center;

FIG. 4 is a sectional diagram illustrating structure of a first grating relating to the exemplary embodiment;

FIG. 5 is a plane view illustrating the structure of the first grating relating to the exemplary embodiment;

FIG. 6 is a sectional diagram illustrating structure of a second grating relating to the exemplary embodiment

FIG. 7 is a plane view illustrating the structure of the second grating relating to the exemplary embodiment; and

FIG. 8 is a perspective diagram illustrating schematic structure of the X-ray device relating to the exemplary embodiment.

### DETAILED DESCRIPTION

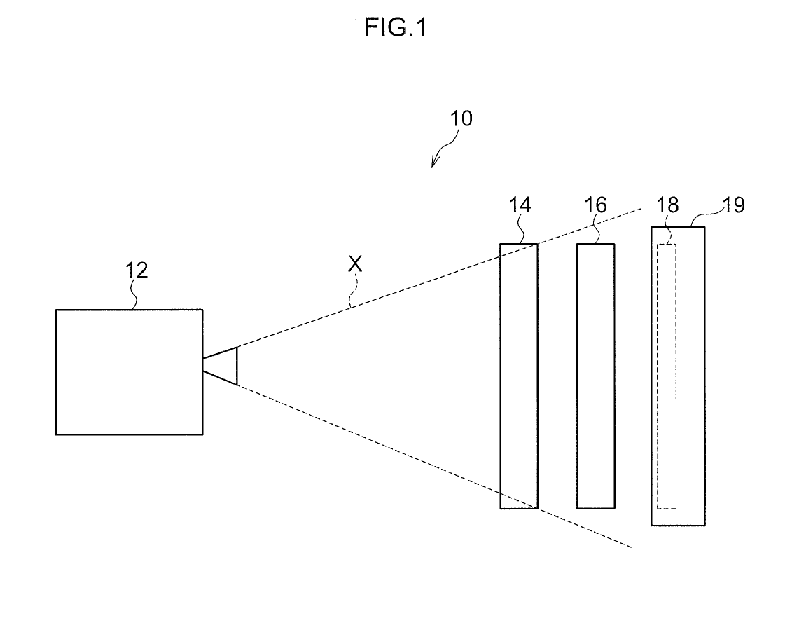

FIG. 1 shows a schematic diagram illustrating schematic structure of an X-ray device 10 relating to a present exemplary embodiment.

The X-ray device 10 relating to the present exemplary embodiment is provided with, as principal structures, a radiation source 12, a diffraction grating 14 (a first grating), an absorption grating 16 (a second grating), and an imaging section 19 incorporating an X-ray image detector 18 such as an FPD or the like.

The radiation source 12 relating to the present exemplary embodiment is a radiation source that causes laser light to collide with an electron beam and generates X-rays by inverse Compton scattering. The X-rays generated by the radiation source 12 are irradiated at the X-ray image detector 18 of the imaging section 19 via the diffraction grating 14 and the absorption grating 16.

The diffraction grating 14 diffracts the incident X-rays. The absorption grating 16 is disposed downstream by a predetermined Talbot interference distance at which a self-image of the X-rays diffracted by the diffraction grating 14 is formed by the Talbot interference effect. The absorption grating 16 generates moire fringes by superposition of the self-image of the diffraction grating 14 with the absorption grating 16. The absorption grating 16 is made to be movable, by an unillustrated movement mechanism, substantially in parallel with the face of the diffraction grating 14.

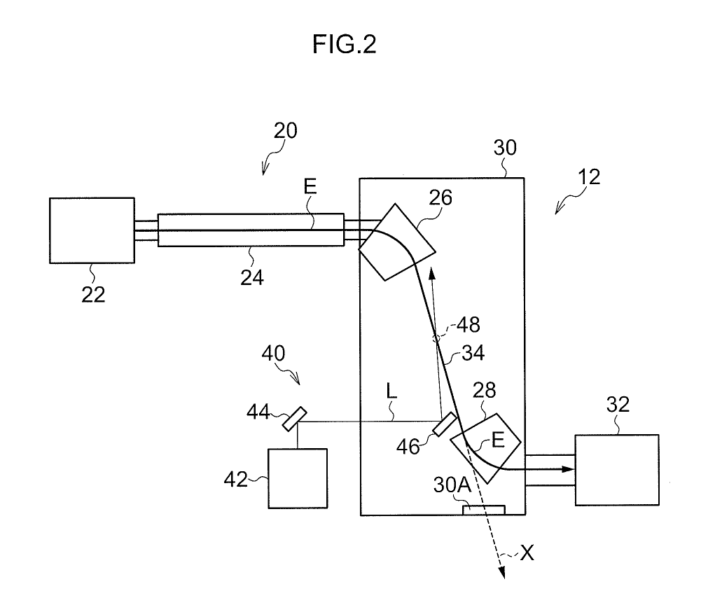

FIG. 2 shows a structural diagram illustrating structure of the radiation source 12 relating to the present exemplary embodiment.

The radiation source 12 is provided with an electron beam generation device 20 and a laser light generation device 40. An electron beam E and laser light L are caused to collide and X-rays are generated to serve as radiation by inverse Compton scattering.

The electron beam generation device 20 is provided with an electron gun 22, a linear acceleration tube 24, a first deflection magnet 26, a second deflection magnet 28, a vacuum chamber 30 and an electron beam dump 32.

The linear acceleration tube 24 accelerates the incident electron beam with microwaves supplied with a predetermined frequency (for example, 11.424 GHz) from a high frequency electric supply, which is not illustrated.

The electron gun 22 is a device that generates an electron beam. The electron gun 22 generates the electron beam in pulses that are synchronized with the frequency of the microwaves supplied to the linear acceleration tube 24. The electron beam generated by the electron gun 22 is incident on the linear acceleration tube 24 and is accelerated inside the linear acceleration tube 24.

The electron beam E that has passed through the linear acceleration tube 24 is incident at the first deflection magnet 26. The first deflection magnet 26 bends the path of the incident electron beam E with a magnetic field and causes the electron beam E to pass along a predetermined linear path 34 in the vacuum chamber 30. The electron beam E that has passed along the linear path 34 in the vacuum chamber 30 is incident at the second deflection magnet 28. The second deflection magnet 28 bends the path of the incident electron beam E with a magnetic field and guides the electron beam E to the electron beam dump 32.

The electron beam dump 32 traps the electron beam E that has passed along the linear path 34 and prevents leakage of the electron beam E.

The laser light generation device 40 is provided with a laser device 42 and laser reflection mirrors 44 and 46.

The laser device 42 generates laser light L in pulses. The laser light L generated by the laser device 42 is reflected by the laser reflection mirrors 44 and 46, in that order, and is guided so as to intersect with the aforementioned linear path 34 in the vacuum chamber 30.

At an intersection point 48 of the linear path 34 with the laser light L, the electron beam E and the laser light L collide, inverse Compton scattering occurs, and X-rays are generated.

An X-ray exit window 30A is formed in the vacuum chamber 30 in line with the linear path 34. The X-ray exit window 30A is structured of a material with high transmittance to X-rays, for example, a plastic, a glass, a metal with high X-ray transmittance (such as beryllium) or the like. The X-rays generated at the intersection point 48 are emitted to the outside through the X-ray exit window 30A, and are irradiated at the diffraction grating 14 shown in FIG. 1.

Now, the X-rays generated by inverse Compton scattering vary depending on angle, with the energies of the X-rays being lower and the wavelengths being larger for X-rays whose angle with respect to the direction of travel of the electron beam where the electron beam E and the laser light L collide is larger.

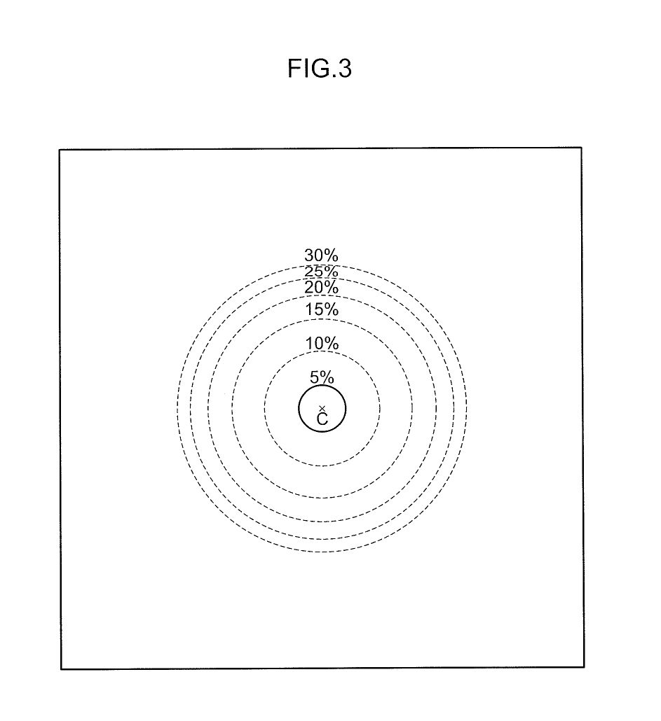

FIG. 3 shows variations in X-ray energy in accordance with distance from a center, the center being in line with the direction of travel of the electron beam where the electron beam E and the laser light L collide, as proportional decreases in energy from the center.

As illustrated in FIG. 3, with the direction of travel of the energy beam where the electron beam E and the laser light L collide serving as the center, the X-ray energy generated by the inverse Compton scattering spreads in concentric circles, with the energy at the center being higher and the energy decreasing toward the edges. In other words, the larger the angle of an X-ray with respect to the direction of travel of the energy beam where the electron beam E and the laser light L collide, the longer the wavelength and the lower the energy.

The energy of the X-rays generated by the inverse Compton scattering is proportional to the square of the energy of the electron beam E and inversely proportional to the wavelength of the laser light L.

The radiation source 12 is capable of altering the energy of the electron beam E. Thus, the energies of the X-rays generated by the inverse Compton scattering may be altered.

In the present exemplary embodiment, laser light L with a constant wavelength is collided with the electron beam E and the angular distribution of energies of the generated X-rays is kept constant. The distance between the radiation source 12 and the diffraction grating 14 is set to a particular positional relationship. A position at which the diffraction grating 14 intersects with a straight line extending, from the point of collision of the electron beam E with the laser light L, in the direction of travel of the electron beam at the collision serves as a center position, and the wavelengths of the X-rays are longer where distances from the central position are greater. Because the distance between the radiation source 12 and the diffraction grating 14 is set to the particular relationship, the wavelengths of the X-rays that are irradiated are set in accordance with their positions at the diffraction grating 14.

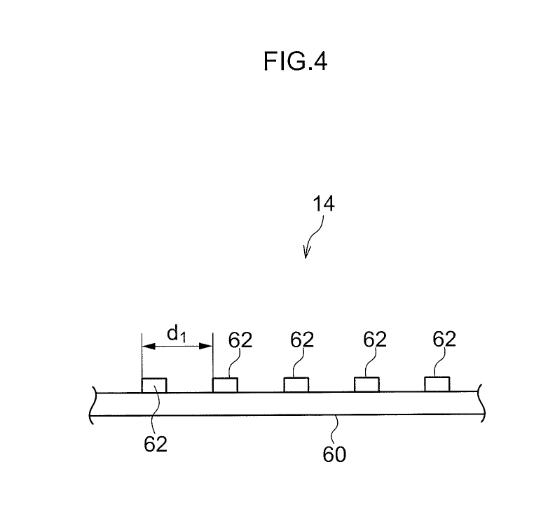

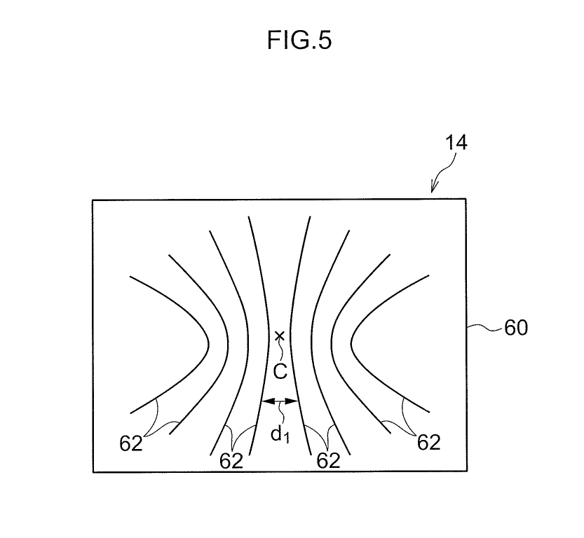

FIG. 4 shows a sectional diagram illustrating structure of the diffraction grating 14 relating to the present exemplary embodiment, and FIG. 5 shows a plane view illustrating structure of the diffraction grating 14 relating to the present exemplary embodiment.

As illustrated in FIG. 4, the diffraction grating 14 is provided with a base plate 60 and grating members 62 (first members) that are mounted at the base plate 60. It is sufficient that the base plate 60 be a material with high transmittance of X-rays; for example, a glass may be used. It is preferable if the grating members 62 are members with low transmittance of X-rays; for example, a metal may be used. The grating members 62 provide a phase modulation from about 80° to 100° degrees (ideally 90°) to the irradiated X-rays, constituting what is known as a phase diffraction grating. When the diffraction grating 14 is a phase diffraction grating that diffracts radiation with the grating members 62, it is preferable if thicknesses of the grating members 62 are varied to match wavelength variations of the X-rays, being preferably at least 1 μm and at most 10 μm.

Next, conditions in which Talbot interference occurs are described. When the diffraction grating 14 is a phase diffraction grating, a Talbot interference distance Z₁ at which a self-image of the diffraction grating 14 is formed by the Talbot interference effect is found from the following expression (1).

Z₁=(m+½)×(d₁×d₂)λ, (1)

In this expression, m is an integer, d₁ is a pitch of the grating members 62 of the diffraction grating 14, d₂ is a pitch of grating members 72 of the absorption grating 16, and λ is the wavelength of the X-rays.

The pitch d₂ of the absorption grating 16 is established to satisfy the following expression with respect to the pitch d₁ of the diffraction grating 14.

d₂=(Z₀+Z₁)×d₁/Z₀ (2)

Here, Z₀ is a distance from the radiation source 12 to the diffraction grating 14.

For example, if m=0, from expressions (1) and (2), the Talbot interference distance Z₁ is as follows.

Z₁=(d₁²/2λ)×(Z₀×Z₁)/Z₀ (3)

Therefore,

Z₁=Z₀d₁²/(2λZ₀−d₁²) (4)

Now, as mentioned above, the X-rays generated by the radiation source 12 vary depending on angle, and the wavelengths λ of the X-rays are longer for X-rays whose angles with respect to the direction of travel of the electron beam where the electron beam E and laser light L collide are larger. Therefore, for example, if the pitch d₁ of the grating members 62 of the diffraction grating 14 is a fixed value, the Talbot interference distance Z₁ would vary with the wavelengths λ of the X-rays.

Accordingly, in order to make the Talbot interference distance Z₁ constant in the present exemplary embodiment, as illustrated in FIG. 5, the grating members 62 on the base plate 60 are formed to be curved such that the pitches of the grating members 62 are larger where distances from the center position C are larger, the center position C being the position intersecting the line extending from the collision point between the electron beam E and laser light L in the direction of travel of the electron beam at the collision. Specifically, from the above expression (3), the pitch d₁ of the grating members 62 at respective positions of the diffraction grating 14 varies such that, with respect to the wavelengths λ of the X-rays irradiated at those positions, d₁=(2λZ₀Z₁/(Z₀+Z₁))^{1/2}.

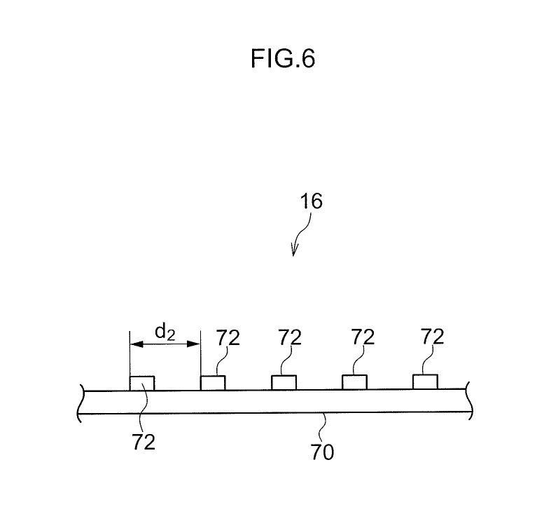

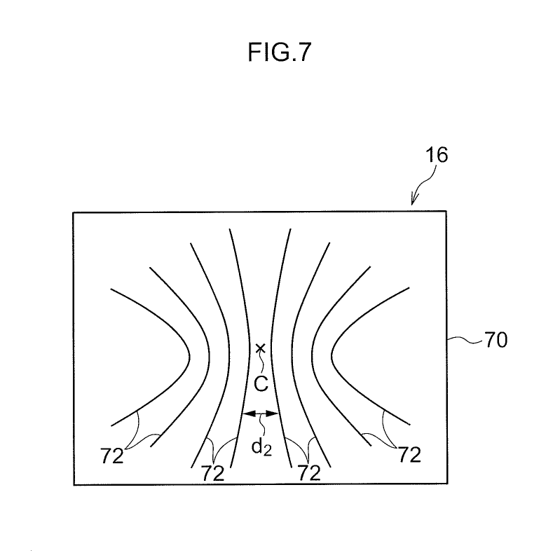

At the absorption grating 16, as illustrated in FIG. 6, the plural grating members 72 (second members) are formed mounted on a base plate 70 that is formed of a member with high transmittance of X-rays, similarly to the diffraction grating 14. As illustrated in FIG. 7, the absorption grating 16 is formed so as to satisfy the above expression (2). That is, the pitch d₂ of the grating members 72 of the absorption grating 16 is formed as pitch d₂ which is larger than the pitch d₁ of the grating members 62 of the diffraction grating 14 by the ratio of the distance (Z₀+Z₁) of the absorption grating 16 from the radiation source 12 to the distance Z₀ of the diffraction grating 14 from the radiation source 12.

Next, operation of the present exemplary embodiment will be described.

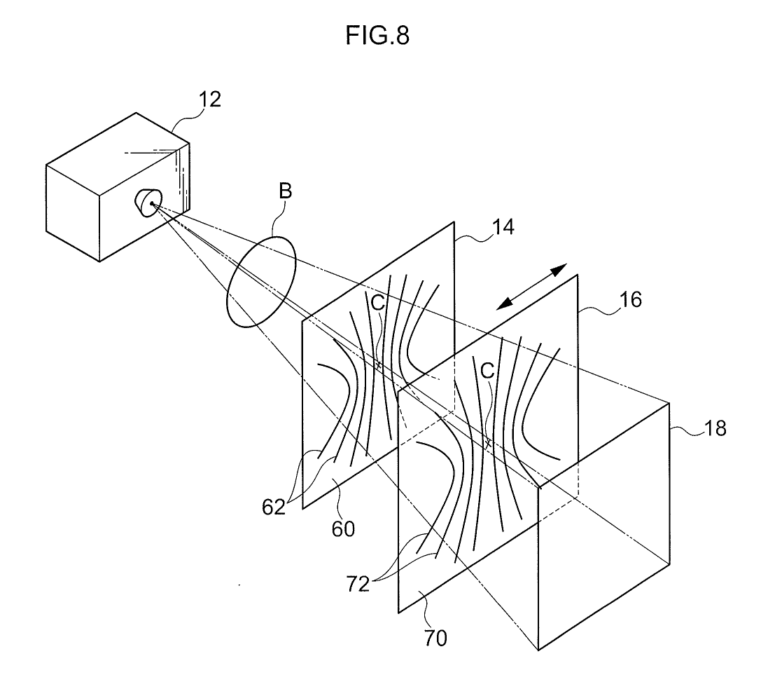

In the X-ray device 10, when a phase contrast image is to be imaged, as illustrated in FIG. 8, X-rays are irradiated from the radiation source 12 in a state in which a portion to be imaged B is at the side of the diffraction grating 14 at which the radiation source 12 is disposed.

The X-rays generated by the radiation source 12 pass through the portion to be imaged B and are irradiated at the X-ray image detector 18 of the imaging section 19 via the diffraction grating 14 and the absorption grating 16.

The X-rays irradiated from the radiation source 12 vary depending on angle. The larger the angles of the X-rays with respect to the direction of travel of the electron beam where the electron beam E and the laser light L collide, the lower the energies of the X-rays and the longer the wavelengths of the X-rays.

However, in the present exemplary embodiment, because the pitches of the grating members 62 of the diffraction grating 14 are formed such that, at respective positions, d₁=(2λZ₀Z₁/(Z₀+Z₁))^{1/2} in relation to the wavelengths of the X-rays irradiated at those positions, a self-image may be formed by the Talbot interference effect at a position at the Talbot interference distance Z₁=d₁d₂/2λ from the diffraction grating 14. As a result, moire fringes are produced beyond the absorption grating 16 that is disposed at a position at the distance Z₁ from the diffraction grating 14.

Hence, in the X-ray device 10 relating to the present exemplary embodiment, similarly to the related art, a phase contrast image may be obtained by a fringe scanning method in which a plural number of images are imaged by the X-ray image detector 18 while the absorption grating 16 is translated in steps of a predetermined pitch by the unillustrated movement mechanism and, from changes in respective pixel values obtained by the X-ray image detector 18, an angular distribution (a differential image of phase shifts) of the X-rays refracted by the imaging subject is acquired. Note that it is necessary to take account of the differences in pitch of the diffraction gratings at different locations when calculating the phase contrasts.

Thus, according to the present exemplary embodiment, because the grating members 62 of the diffraction grating 14 and the grating members 72 of the absorption grating 16 are formed such that spacings between the grating members 62 and the grating members 72 are larger where distances from the center position of the radiation irradiated from the radiation source 12 are larger, an excellent phase contrast image may be obtained even when the radiation source 12 that irradiates radiation by inverse Compton scattering is used.

Hereabove, the present invention has been described using the above exemplary embodiment, but the technical scope of the present invention is not to be limited to the scope described in the above exemplary embodiment. Numerous modifications and improvements may be applied to the above exemplary embodiment within a scope not departing from the spirit of the present invention, and modes to which these modifications and/or improvements are applied are to be encompassed by the technical scope of the invention.

For example, in the above exemplary embodiment, a structure in which the diffraction grating 14 is a phase diffraction grating is described, but the present invention is not to be limited thus. For example, the diffraction grating 14 may be structured as an absorption grating. If the diffraction grating 14 is an absorption grating that absorbs radiation with the grating members 62, it is preferable if the thicknesses of the grating members 62 are from 10 μm to 100 μm in the absorption grating. When the diffraction grating 14 is an absorption grating, the Talbot interference distance Z₁ at which a self image is formed by the Talbot interference effect is found from the following expression (5).

Z₁=m×d₁d₂a/λ (5)

Here, d₁ and d₂ satisfy expression (2). When the diffraction grating 14 is an absorption grating, if, for example, m=1, the pitch between the grating members 62 of the diffraction grating 14 is formed such that d₁=(λZ₀Z₁/(Z₀+Z₁))^{1/2} in relation to the wavelengths λ of the X-rays irradiated at respective positions. Thus, a self-image may be formed by the Talbot interference effect at the position of the Talbot interference distance Z₁=d₁d₂/λ. As illustrated in FIG. 7, similarly to the diffraction grating 14, the absorption grating 16 is formed such that, given that Z₀ is the distance from the radiation source 12 to the diffraction grating 14, d₂=d₁×(Z₀+Z₁)/Z₀. Thus, an image may be reliably obtained with X-rays diffracted by the diffraction grating 14.

In the above exemplary embodiment, a structure is described in which thicknesses of the grating members 62 of the diffraction grating 14 are substantially equal. However, because the pitch of the grating members 62 of the diffraction grating 14 varies with the wavelengths λ of the X-rays irradiated at the respective positions, the grating members 62 may be formed such that the thicknesses are thinner where the distances from the center position C are larger, the center position C being the position intersecting the line extending from the collision point between the electron beam E and laser light L in the direction of travel of the electron beam at the collision. Thus, differences in X-ray amounts transmitted through the diffraction grating 14 may be kept small.

In the above exemplary embodiment, a case is described in which the laser light L with a constant wavelength and the electron beam E are collided by the radiation source 12 and an angular distribution of the energy of the generated X-rays is kept constant, but the present invention is not to be limited thus. For example, the energy of the electron beam E may be varied in accordance with one or both of the type and thickness of a portion to be imaged, and radiations with different energies may be separately irradiated from the radiation source 12. In this situation, a plural number of the diffraction grating 14 and the absorption grating 16 with different degrees of change in the spacings of the grating members 62 and the grating members 72 may be prepared, with the spacings between the grating members 62 and the grating members 72 being varied in accordance with the angular distributions of the energies of the X-rays that are to be irradiated from the radiation source 12 during imaging in accordance with the type and thickness of the portion to be imaged, and the diffraction grating 14 and the absorption grating 16 may be exchanged by a user.

In the above exemplary embodiment, a structure in which the X-ray device 10 is provided with the radiation source 12, the diffraction grating 14, the absorption grating 16 and the imaging section 19 incorporating the X-ray image detector 18 is described, but the present invention is not to be limited thus. For example, the radiation source 12, the diffraction grating 14, the absorption grating 16 and the imaging section 19 may be respectively separate devices and constituted as a radiographic imaging system.

Furthermore, the structures described in the above exemplary embodiment are examples. Obviously, unnecessary portions may be removed, new portions may be added, and connection conditions and the like may be altered within a scope not departing from the spirit of the present invention.

What is claimed is:

1. A radiographic imaging device comprising:
a radiation source that irradiates radiation generated by inverse Compton scattering;
a first grating at which first members that diffract or absorb radiation are formed side by side such that pitches thereof are larger where distances from a center position of the radiation irradiated from the radiation source are larger, the first grating diffracting or absorbing radiation irradiated from the radiation source with the first members;
a second grating that is disposed at a position at which Talbot interference is produced by the radiation diffracted or absorbed by the first grating, and at which second members that absorb radiation are formed side by side such that pitches thereof are larger where distances from the center position of the radiation irradiated from the radiation source are larger; and
a radiation detector that detects radiation that has passed through the second grating.

2. The radiographic imaging device according to claim 1, wherein the first members are formed such that the pitches between the first members are larger in proportion to the square roots of wavelengths λ of the radiation irradiated at respective positions of the first grating from the radiation source.

3. The radiographic imaging device according to claim 1, wherein the second members are formed with pitches that are larger than the pitches of the first members of the first grating by a ratio of a distance from the radiation source to the second grating to a distance from the radiation source to the first grating.

4. The radiographic imaging device according to claim 1, wherein
the radiation source is capable of separately irradiating radiations with different energies, and
pluralities of the first grating and the second grating are prepared with different degrees of change of the pitches between the first members and between the second members, and the first grating and second grating are exchangeable.

5. The radiographic imaging device according to claim 4, wherein the radiation source separately irradiates the radiations with different energies in accordance with at least one of types and thicknesses of portions to be imaged.

6. The radiographic imaging device according to claim 1, wherein the first members of the first grating and the second members of the second grating are formed such that thicknesses thereof are thinner where the distances from the center position of the radiation irradiated from the radiation source are larger.

7. A radiographic imaging system comprising:
a radiation source that irradiates radiation generated by inverse Compton scattering;
a first grating at which first members that diffract or absorb radiation are formed side by side such that pitches thereof are larger where distances from a center position of the radiation irradiated from the radiation source are larger, the first grating diffracting or absorbing radiation irradiated from the radiation source with the first members;
a second grating that is disposed at a position at which Talbot interference is produced by the radiation diffracted or absorbed by the first grating, and at which second members that absorb radiation are formed side by side such that pitches thereof are larger where distances from the center position of the radiation irradiated from the radiation source are larger; and
a radiation detector that detects radiation that has passed through the second grating.
